(19) United States
(12) Patent Application Publication
(10) Pub. No.: US 2006/0051653 A1
(43) Pub. Date: Mar. 9, 2006

(54) Fuel cell system and stack

(76) Inventor: Sang-Won Lee, Suwon-si (KR)

Correspondence Address: CHRISTIE, PARKER & HALE, LLP, PO BOX 7068, PASADENA, CA, 91109-7068, US

(21) Appl. No.: 11/221,468

(22) Filed: Sep. 7, 2005

(30) Foreign Application Priority Data
Sep. 8, 2004 (KR) 10-2004-0071667

(51) Int. Cl. H01M 8/02; H01M 8/10; H01M 8/06

(52) U.S. Cl. 429/37; 429/32; 429/19

(57) ABSTRACT

A stack for a fuel cell system generating electrical energy from an electrochemical reaction of hydrogen and oxygen includes one or more electricity generating elements having a membrane-electrode assembly and an inner separator, the inner separator being disposed on either side of the membrane-electrode assembly. A pair of outermost separators positioned at opposite ends of the stack, respectively, to form current collecting units having opposite polarities. The pair of outermost separators are fastened to provide a coupling force (or pressure) to the electricity generating elements in an opposing direction and to closely connect the electricity generating elements with each other.

### CROSS-REFERENCE TO RELATED APPLICATION

This application claims priority to and the benefit of Korean Patent Application No. 10-2004-0071667, filed in the Korean Intellectual Property Office on Sep. 8, 2004, the entire content of which is incorporated herein by reference.

### BACKGROUND OF THE INVENTION

1. Field of the Invention

The present invention relates to a fuel cell system. More particularly, the present invention relates to a fuel cell system having an improved stack structure.

2. Description of the Related Art

A fuel cell is a power generation system for producing electrical energy from an electrochemical redox reaction of oxygen and a fuel, such as hydrogen or a hydrocarbon-based material, such as methanol, ethanol, natural gas, or the like.

A fuel cell that uses hydrogen as a fuel can obtain its hydrogen by reforming methanol or ethanol. Such a fuel cell can be applied to a wide range of applications, such as for portable electrical power sources for automobiles, distributed power sources for houses and public buildings, and small electrical power sources for electronic devices.

The fuel cell has at least one unit cell that includes a membrane-electrode assembly (MEA) for generating electricity from a redox reaction of hydrogen and oxygen, and a separator adjacent to both sides of the membrane-electrode assembly. The separators are for supplying hydrogen and oxygen to the membrane-electrode assembly. The separators can also be referred to as bipolar plates. A plurality of such unit cells are stacked adjacent to one another to thereby form a stack.

A stack can be manufactured by coupling two separate pressing plates of metal to the outside of the two outermost separators and inserting a current collecting plate between each outermost separator and each pressing plate, and then fastening the stack with a fastener.

In a conventional fuel cell system, a plurality of unit cells are stacked, and separate current collecting plates and pressing plates are provided to the two outermost stacked unit cells to form a stack. Because of this, the structure and manufacturing process of a conventional stack are complicated such that the cost for manufacturing is very high and the productivity is very low.

### SUMMARY OF THE INVENTION

An embodiment of the present invention provides a fuel cell system in which a stack is formed with a simple structure.

In one embodiment of the present invention, a stack for a fuel cell system for generating electrical energy from an electrochemical reaction of hydrogen and oxygen includes one or more electricity generating elements having a membrane-electrode assembly and an inner separator, the inner separator being disposed on either side of the membrane-electrode assembly. A pair of outermost separators is positioned at opposite ends of the stack, respectively, to form current collecting units having opposite polarities. The pair of outermost separators are fastened to provide a coupling force (or pressure) to the electricity generating elements in an opposing direction and to closely connect the electricity generating elements with each other.

One of the pair of outermost separators forming the current collecting units may have hydrogen passage paths formed on a side thereof adjacent to its adjacent membrane-electrode assembly and to supply hydrogen gas thereto, and another one of the pair of outermost separators forming the current collecting units may have oxidizing agent passage paths formed on a side thereof adjacent to its adjacent membrane-electrode assembly and to supply oxidizing agent thereto.

A terminal element may be formed at each of the pair of outermost separators forming the current collecting units.

The pair of outermost separators forming the current collecting units may be formed from a metallic material.

The hydrogen passage paths and the oxidizing agent passage paths of the pair of outermost separators forming the current collecting units may be formed on metal plates by press working.

The pair of outermost separators forming the current collecting units may include a coating layer on a surface thereof, the coating layer being formed of a material selected from the group consisting of gold, silver, conductive carbon, inorganic compound, boride, conductive resin, and combinations thereof.

The pair of outermost separators may have opposing surfaces that are larger in area than the inner separator interposed between the pair of outermost separators.

The stack may have an insulating connection member, wherein the pair of outermost separators are fastened to each other by the insulating connection member.

The connection member may include a plurality of connecting rods penetrating through all the electricity generating elements, and a plurality of nuts fastened to both ends of each of the connecting rods.

The stack may have an insulating layer, wherein the insulating layer is formed on a surface of each of the connecting rods.

The connection member may include a plurality of connecting rods penetrating the pair of outermost separators, and a plurality of nuts fastened to both ends of each of the connecting rods.

In one embodiment of the present invention, a fuel cell system contains a stack for generating electrical energy from the electrochemical reaction of hydrogen and oxygen, a fuel supplier for supplying a fuel containing hydrogen to the stack, and an oxygen supplier for supplying oxygen to the stack.

The stack includes one or more electricity generating elements having a membrane-electrode assembly and an inner separator, the inner separator being disposed on either side of the membrane-electrode assembly. A pair of outermost separators is positioned at opposite ends of the stack, respectively, to form current collecting units having opposite polarities. The pair of outermost separators are fastened to provide a coupling force (or pressure) to the electricity generating elements in an opposing direction and to closely connect the electricity generating elements with each other.

The one or more electricity generating elements may include a plurality of electricity generating elements, the plurality of the electricity generating elements being stacked with each other to form the stack.

The fuel supplier may include a fuel tank for storing the fuel containing hydrogen, and a fuel pump coupled to the fuel tank.

The fuel supplier may include a reformer coupled to the one or more electricity generating elements and the fuel tank, the reformer being supplied with the fuel from the fuel tank to generate a hydrogen reformate (e.g., a hydrogen-rich gas or a hydrogen gas), then supplying the hydrogen reformate to the one or more electricity generating elements.

The oxygen supplier may include a pump for drawing an oxidizing agent and supplying the oxidizing agent to the one or more electricity generating element.

According to the embodiments of the invention, since the outermost separators of the stack are formed to function both at pressing plates for coupling the stack and current collecting plates for collecting current, the structure of the stack can be simple and compact, thereby resulting in decreasing the unit cost for manufacturing as well as simplifying the manufacturing process of the stack.

### BRIEF DESCRIPTION OF THE DRAWINGS

FIG. 1 is a schematic diagram illustrating an entire structure of a fuel cell system according to an embodiment of the present invention.

FIG. 2 is an exploded perspective view illustrating a stack according to a first embodiment of the present invention.

FIG. 3 is an exploded perspective view illustrating the stack according to the first embodiment of the present invention in a state where one of the outermost separators is rotated.

FIG. 4 is a cross-sectional view of the stack illustrated in FIG. 2 in an assembled state.

FIG. 5 is a cross-sectional view illustrating a stack according to a second embodiment of the present invention.

FIG. 6 is an exploded perspective view illustrating a stack according to a third embodiment of the present invention.

### DETAILED DESCRIPTION

Embodiments of the present invention will hereinafter be described in more detail with reference to the accompanying drawings.

However, the present invention may have various modifications and equivalent arrangements and it should be understood by those skilled in the art that the invention is not limited to the described embodiments.

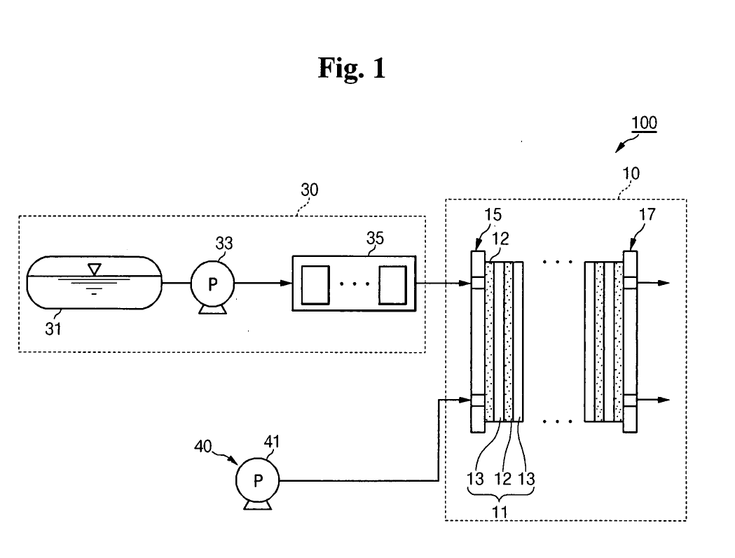

FIG. 1 is a schematic diagram illustrating an entire structure of a fuel cell system 100 according to an embodiment of the present invention.

Referring to FIG. 1, the fuel cell system 100 adopts a polymer electrolyte membrane fuel cell (PEMFC) scheme that first generates hydrogen gas by reforming a hydrogen-containing fuel and then generates electricity by electrochemically reacting the hydrogen with an oxidizing agent.

A fuel used to generate electricity in the fuel cell system 100 can include any type of suitable fuel, such as methanol, ethanol, natural gas, or the like, whether in liquid or gas form. However, in the following description, the fuel will be described as being in the liquid form for convenience of description purposes.

The fuel cell system 100 can use either oxygen gas stored in a separate storage unit as the oxidizing agent or air including oxygen as the oxidizing agent. However, hereinafter, the latter type of oxidizing agent will be described as an example.

The fuel cell system 100 includes a stack 10 for generating electrical energy from a chemical reaction of hydrogen and oxygen, a fuel supplier 30 for generating hydrogen gas from the fuel and for supplying it to the stack 10, and an oxygen supplier 40 for supplying air to the stack 10.

The stack 10 includes at least one fuel cell that is coupled to the fuel supplier 30 and the oxygen supplier 40. The stack 10 is supplied with hydrogen from the fuel supplier 30 and air from the oxygen supplier 40, and generates electrical energy from the electrochemical reaction of hydrogen and oxygen.

The fuel supplier 30 includes a fuel tank 31 for storing fuel, a fuel pump 33 for discharging the fuel from the fuel tank 31, and a reformer 35. The reformer 35 is supplied with the fuel from the fuel tank 31, reforms the fuel to generate hydrogen, and supplies the hydrogen to the stack 10.

The oxygen supplier 40 includes at least one air pump 41 with a predetermined pumping power for drawing air and for supplying the air to the stack 10.

The reformer 35 of the fuel supplier 30 has a conventional structure that generates a hydrogen reformate (e.g., a hydrogen-rich gas or a hydrogen gas) from the fuel through a chemical catalytic reaction using thermal energy and reduces the concentration of carbon monoxide contained in the hydrogen reformate. The reformer 35 generates the hydrogen (i.e., the hydrogen reformate) from the fuel through a catalytic reaction of the fuel such as a steam reforming reaction, a partial oxidation reaction, and/or an auto-thermal reaction.

In addition, the reformer 35 reduces the concentration of carbon monoxide contained in the hydrogen reformate through a water-gas shift reaction of the hydrogen reformate, a preferential CO oxidation reaction, a purification of the hydrogen process using a separating membrane, or the like.

Alternatively, the fuel cell system 100 of the present invention may employ a direct oxidation fuel cell scheme that directly supplies fuel to the stack 10 and generates electrical energy through an electrochemical reaction between the fuel and oxygen.

Unlike the fuel cell system employing the PEMFC scheme, a fuel cell system employing the direct oxidation fuel cell scheme does not require the reformer 35 as shown in FIG. 1. Instead, the fuel supplier 30 supplies the fuel stored in the fuel tank 31 directly to the stack 10 through the fuel pump 33. The fuel cell system 100 employing the PEMFC scheme will be described in more detail for exemplary purposes, and the present invention is not thereby limited.

At the time of operating the fuel cell system 100, if the hydrogen gas generated at the reformer 35 of the fuel supplier 30 and the air drawn by the air pump 41 are both supplied to the stack 10, the stack 10 generates electrical energy from the electrochemical reaction of the hydrogen gas and the oxygen contained in the air.

Various embodiments of the stack 10 applicable to the above described fuel cell system 100 will be described in more detail with reference to the attached drawings.

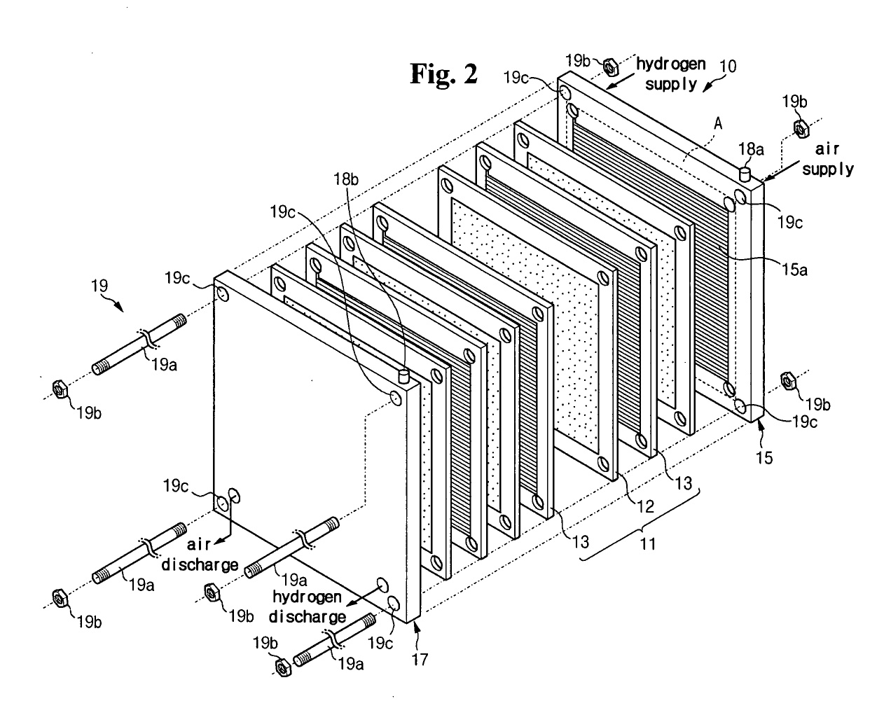

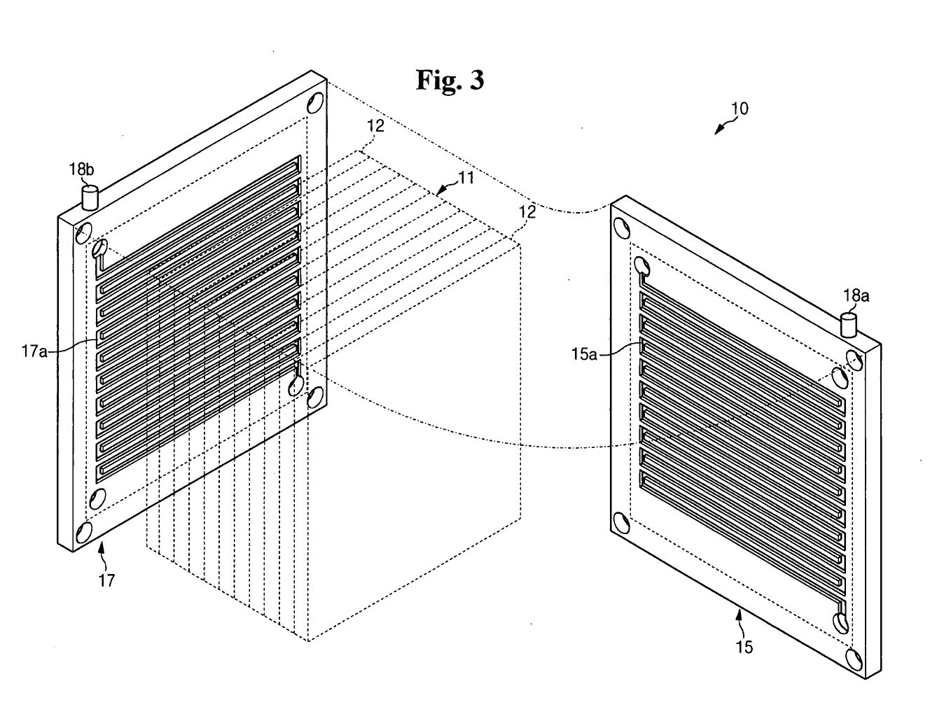

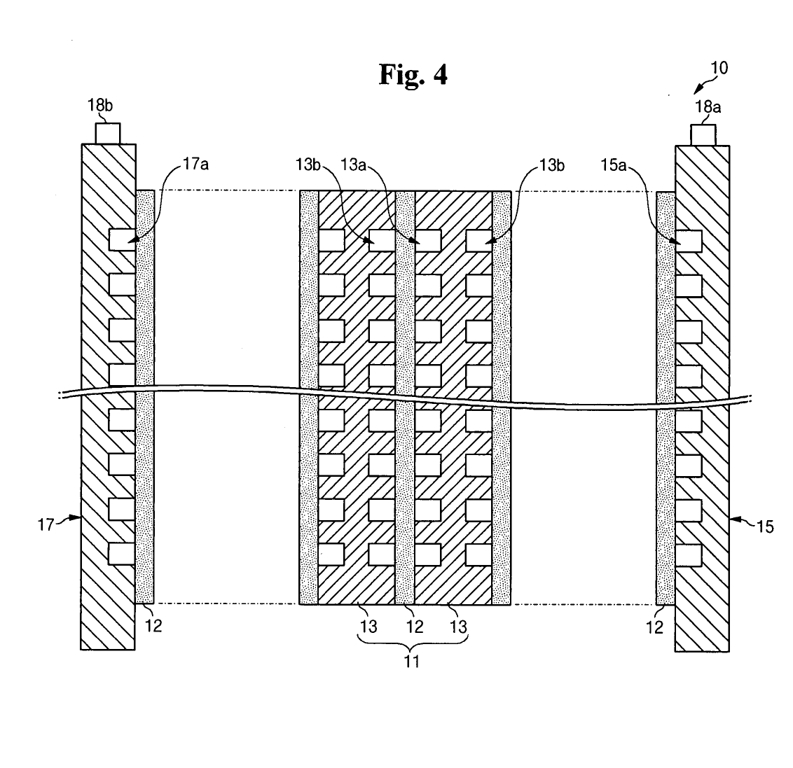

FIG. 2 is an exploded perspective view illustrating a stack 10 according to a first embodiment of the present invention, and FIG. 3 is an exploded perspective view illustrating the stack 10 according to the first embodiment of the present invention in a state where one of the outermost separators is rotated. FIG. 4 is a cross-sectional view of the stack 10 illustrated in FIG. 2 in an assembled state.

Referring to FIGS. 2, 3, and 4, the stack 10 includes an electricity generating element (or a unit cell) 11 for generating electrical energy. In the electricity generating element 11, separators (or inner separators) 13 are located on both sides of a membrane-electrode assembly (MEA) 12. The separators 13 can also be referred to as bipolar plates. The stack 10 can be formed as a set of electricity generating elements 11 by stacking the set of electricity generating elements 11 adjacent to one another.

The MEA 12 is located between the separators 13 and includes an anode (not shown) formed on one side, a cathode (not shown) formed on the other side, and an electrolyte membrane (not shown) formed between the anode and the cathode. The anode decomposes hydrogen into hydrogen ions (protons) and electrons through the oxidation reaction of the hydrogen gas supplied from the separator 13. The cathode generates heat of a certain temperature and moisture through the reduction reaction of the oxygen in the air supplied from the separator 13 and the protons and electrons moved from the anode. Further, the electrolyte membrane is formed of a solid polymer electrolyte material with a thickness ranging from 50 μm to 200 μM, and performs a function of exchanging ions by transferring the protons generated at the anode to the cathode.

The separators 13 are positioned substantially adjacent to each other with the MEA 12 interposed therebetween. On surfaces of the separators 13 contacting the MEA 12, hydrogen passage paths 13a and air passage paths 13b are formed. The hydrogen passage paths 13a are located on the anode side of the MEA 12 and supply the anode with hydrogen gas supplied from the reformer 35. The air passage paths 13b are located on the cathode side of the MEA 12 and supply the cathode with oxygen in the air supplied from the air pump 41. In addition, each separator 13 performs a function of a conductor which couples the anode and the cathode in series.

For an exemplary embodiment, as shown in FIGS. 2, 3 and 4 (especially FIG. 4), the hydrogen passage paths 13a and the air passage paths 13b may be formed on one surface and another surface of a separator 13, respectively. Alternatively, one of the hydrogen passage paths 13a and the air passage paths 13b may be formed on one surface of one of the two separators 13 positioned at both sides of the MEA 12. The hydrogen passage paths 13a and the air passage paths 13b may be formed by molding a graphite and/or carbon composite material, or by pressing a metal plate.

A specific embodiment of the separator 13 with regard to how the hydrogen gas and the air are supplied and circulated through the hydrogen passage paths 13a and the air passage paths 13b will not be described in more detail. However, the present invention can include any suitable embodiments that can supply and circulate hydrogen gas and air through the hydrogen passage paths 13a and the air passage paths 13b, and discharge unreacted hydrogen gas and air left behind at the anode and the cathode of the MEA 12.

At the time of operating the fuel cell system 100 according to the embodiment of the present invention, hydrogen gas is supplied to the anode of the MEA 12 through the separator 13, while air containing oxygen is supplied to the cathode of the MEA 12. Therefore, the hydrogen gas is oxidized to generate electrons and protons at the anode. The protons move to the cathode through the MEA 12, but the electrons move not through the MEA 12 but through the separator 13 to the cathode of the MEA 12, thereby generating an electric current, and also water and heat as a byproduct.

In this embodiment, a pair of outermost separators 15 and 17 positioned at opposite ends of the stack 10 respectively form current collecting units having opposite polarities. The outermost separators 15 and 17 have a function of collecting current generated at the electricity generating element 11. Hence, one of the pair of outermost separators 15 and 17 forms a positive (+) terminal element, and another one of the pair of outermost separators 15 and 17 forms a negative (−) terminal element.

The outermost separators 15 and 17 forming the current collecting units are connected to the separators 13 of the electricity generating elements 11 in series, and can function as current collecting plates which collect current flowing through the separators 13. The electricity generating elements 11 are interposed between the pair of outermost separators 15 and 17.

The outermost separators 15 and 17 may be made of metallic materials such as aluminum, copper, iron, and/or cobalt. The metallic materials can enable the outermost separators 15 and 17 to be electrically connected to the separators 13 that are positioned therebetween in close contact with each other. In one embodiment, the outermost separators 15 and 17 may be manufactured by pressing a metal plate using a pair of devices to shape the metal plate into a shape corresponding to the entire shape of the outermost separators 15 and 17. Alternatively, the outermost separators 15 and 17 may be manufactured by injection-molding a metallic material or die-casting a metallic material.

In addition, the outermost separators 15 and 17 can function as a conventional separator. For this function, the stack 10 of this embodiment has an MEA 12 interposed between one of the outermost separators 15 and 17 and one of the adjacent separators 13 adjacent to the MEA 12. In the stack 10, the outermost separator 15 has hydrogen passage paths 15a formed on a side thereof to be close to (or adjacent to) its adjacent MEA 12, and the outermost separator 17 has air passage paths (or oxidizing agent passage paths) 17a formed on a side thereof to be close to (or adjacent to) its adjacent MEA 12.

In other words, the outermost separators 15 and 17 are respectively located on one side of the outermost MEAs 12, and the adjacent separators 13 are respectively located on another side of the outermost MEAs 12 such that the outermost separators 15 and 17 are coupled together with the separators 13 and the outermost MEAs 12 to form the electricity generating elements 11, according to the embodiment of FIGS. 2, 3, and 4. The outermost separators 15 and 17 have opposing surfaces that are larger in area than those of the separators 13 interposed between the pair of outermost separators 15 and 17.

The edges of the outermost separators 15 and 17 extend outwardly from the edge of the separators 13 positioned therebetween. The extended edges of the outermost separators 15 and 17 form a margin represented as A as shown in FIG. 2.

Therefore, the outermost separators 15 and 17 formed of metal are coupled to the separators 13 in series, and each functions both as an electricity generating element 11 and a current collecting unit.

Current generated at the electricity generating elements 11 can be collected by the outermost separators 15 and 17, and the electrical energy collected at the outermost separators 15 and 17 can be outputted to a load (e.g., a current receiving load).

The outermost separators 15 and 17 have terminal elements 18a and 18b, respectively, to output the collected electrical energy to the above-mentioned load. The terminal elements 18a and 18b include a first terminal element 18a connected to the outermost separator 15 and a second terminal element 18b connected to the outermost separator 17. The terminal elements 18a and 18b have opposite polarities such that the second terminal element 18b forms a negative (−) terminal element in a case that the first terminal element 18a forms a positive (+) terminal element.

The stack 10 of the structure as described above has connection members 19 which provide a coupling force to the plurality of electricity generating elements 11 at a predetermined force (or pressure) to couple the elements 11 together. The connection members 19 are provided for preventing or blocking leakage of the hydrogen gas and air and completing the construction of the fuel cell.

The connection members 19 include a plurality of connecting rods 19a penetrating a plurality of connecting holes 19c formed in the margins A of the outermost separators 15 and 17, and nuts 19b screw-fastened to both ends of each of the connecting rods 19a to fix the outermost separators 15 and 17 in place.

Therefore, the nuts 19b are coupled to both ends of the connecting rods 19a that penetrate the connecting holes 19c to press the pair of outermost separators 15 and 17 in place, and thereby the stack 10 according to the first embodiment is fixed at an appropriate pressure. In other words, the outermost separators 15 and 17 perform the function of providing a coupling force (or pressure) to the stack 10 that is similar in function to the conventional end plates.

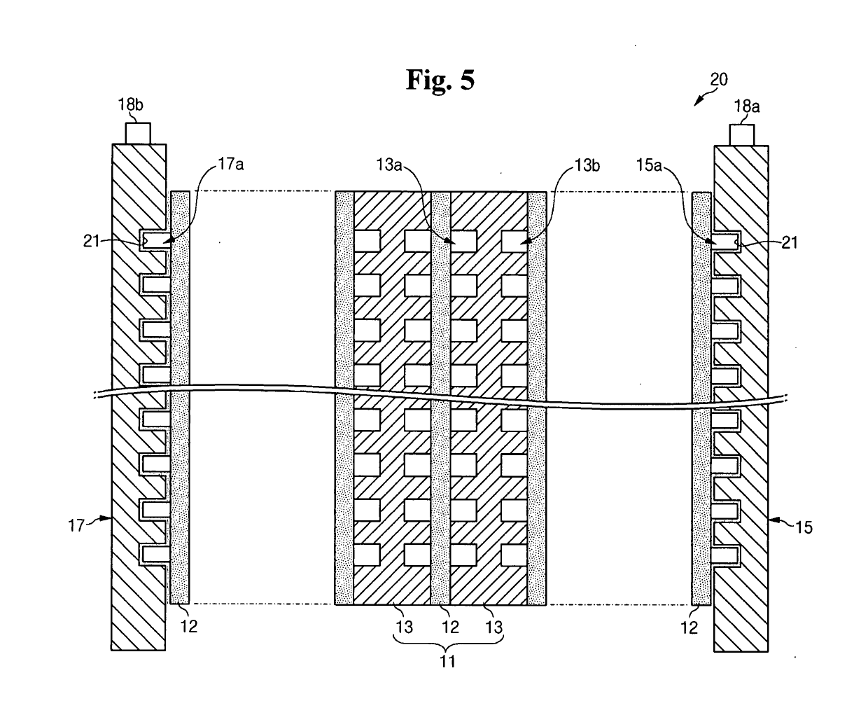

FIG. 5 is a cross-sectional view illustrating a stack according to a second embodiment of the present invention. The elements in FIG. 5 with the same function as the elements in FIG. 4 are assigned the same reference numerals as in FIG. 4.

Referring to FIG. 5, the stack 20 according to this embodiment includes a coating layer 21 on a surface of the outermost separators 15 and 17 forming the current collecting units. The coating layer is formed by a material selected from the group consisting of gold, silver, conductive carbon, inorganic compound, boride, conductive resin, and combinations thereof.

The coating layer 21 is provided for improving the corrosion resistance of the outermost separators 15 and 17 since the outermost separators 15 and 17 are formed of a metallic material.

Because the rest of the construction is substantially the same as the construction of the stack 10 according to the first embodiment, a detailed description of the rest of the stack 20 is omitted.

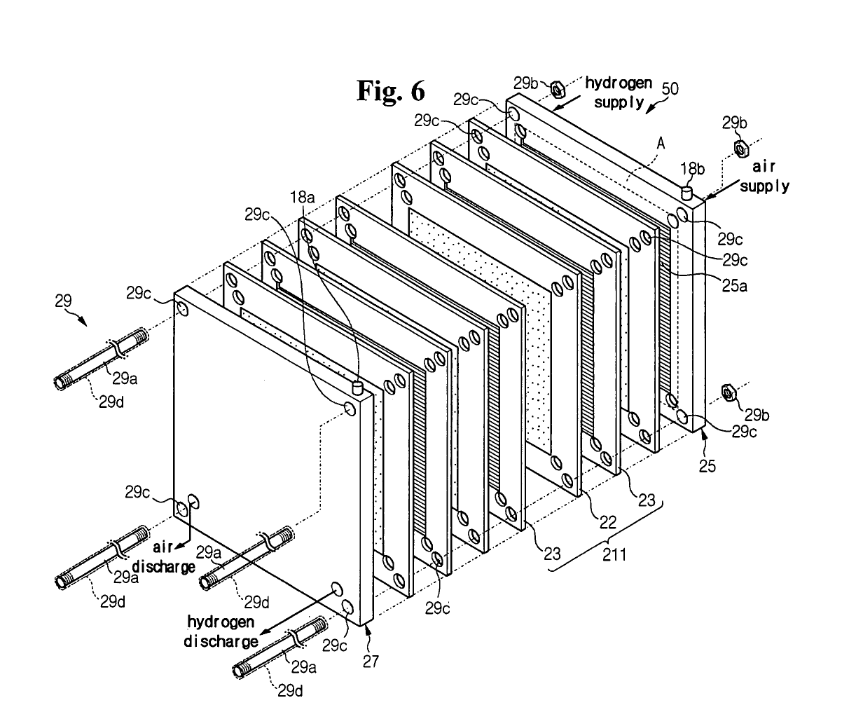

FIG. 6 is an exploded perspective view illustrating a stack according to a third embodiment of the present invention. The elements in FIG. 6 with the same function as the elements in FIG. 2 are assigned the same reference numerals as in FIG. 2.

Referring to FIG. 6, a stack 50 according to this embodiment has outermost separators 25 and 27, MEAs 22 and separators 23 interposed therebetween, and connection members 29 penetrating through all the electricity generating elements 211. The electricity generating elements 211 include the outermost separators 25 and 27 and the separators (or inner separators) 23, and the connection members 29 penetrate the outermost separators 25 and 27 and the separators 23, thereby coupling the plurality of electricity generating elements 211 together. The outermost separators 25 and 27 may be the same or similar in size as the separators 23. The connection members 29, similar to the first embodiment, include connecting rods 29a and nuts 29b fastened to both ends of each of the connecting rods 29a.

In order to couple the stack 50 according to this embodiment using the connection members 29, a plurality of connecting holes 29c are formed in the region of the outermost separators 25 and 27 excluding the passage paths (e.g., passage paths 25a), and the region of the separators 23 interposed between the outermost separators 25 and 27 excluding the passage paths 23a. The connecting rods 29a pass through the connecting holes 29c. On a surface of the connecting rods 29a an insulating layer 29d is formed to thereby insulate each electricity generating element 211 from the connecting rods 29a.

Because the rest of the construction of the stack 50 is substantially the same as the construction of the preceding embodiments, a detailed description of the rest of the stack 50 is omitted.

While the invention has been described in connection with certain exemplary embodiments, it is to be understood by those skilled in the art that the invention is not limited to disclosed embodiment, but, on the contrary, is intended to cover various modifications included within the spirit and scope of the appended claims and equivalents thereof.

What is claimed is:

1. A stack for a fuel cell system for generating electrical energy from an electrochemical reaction of hydrogen and oxygen, the stack comprising:
one or more electricity generating elements having a membrane-electrode assembly and an inner separator, the inner separator being disposed on either side of the membrane-electrode assembly; and
a pair of outermost separators positioned at opposite ends of the one or more electricity generating elements, respectively, the pair of outermost separators forming current collecting units having opposite polarities,
wherein the pair of outermost separators are fastened to provide a coupling force to the electricity generating elements in an opposing direction and to closely connect the electricity generating elements with each other.

2. The stack for a fuel cell system of claim 1, wherein one of the pair of outermost separators forming the current collecting units has hydrogen passage paths formed on a side thereof adjacent to its adjacent membrane-electrode assembly and to supply hydrogen gas thereto, and another one of the pair of outermost separators forming the current collecting units has oxidizing agent passage paths formed on a side thereof adjacent to its adjacent membrane-electrode assembly and to supply oxidizing agent thereto.

3. The stack for a fuel cell system of claim 2, wherein a terminal element is formed at each of the pair of outermost separators forming the current collecting units.

4. The stack for a fuel cell system of claim 2, wherein the pair of outermost separators forming the current collecting units are formed from a metallic material.

5. The stack for a fuel cell system of claim 4, wherein the hydrogen passage paths and the oxidizing agent passage paths of the pair of outermost separators forming the current collecting units are formed on metal plates by press working.

6. The stack for a fuel cell system of claim 5, wherein the pair of outermost separators forming the current collecting units comprise a coating layer on a surface thereof, the coating layer comprising a material selected from the group consisting of gold, silver, conductive carbon, inorganic compound, boride, conductive resin, and combinations thereof.

7. The stack for a fuel cell system of claim 1, wherein the pair of outermost separators have opposing surfaces larger in area than the inner separator interposed between the pair of outermost separators.

8. The stack for a fuel cell system of claim 1, further comprising an insulating connection member, wherein the pair of outermost separators are fastened to each other by the insulating connection member.

9. The stack for a fuel cell system of claim 8, wherein the connection member comprises a plurality of connecting rods penetrating through all the electricity generating elements, and a plurality of nuts fastened to both ends of each of the connecting rods.

10. The stack for a fuel cell system of claim 9, further comprising an insulating layer, wherein the insulating layer is formed on a surface of each of the connecting rods.

11. The stack for a fuel cell system of claim 8, wherein the connection member comprises a plurality of connecting rods penetrating the pair of outermost separators, and a plurality of nuts fastened to both ends of each of the connecting rods.

12. The stack for a fuel cell system of claim 11, wherein an insulating layer is formed on a surface of each of the connecting rods.

13. A fuel cell system comprising:
a stack for generating electrical energy from an electrochemical reaction of hydrogen and oxygen;
a fuel supplier for supplying a fuel containing hydrogen to the stack; and
an oxygen supplier for supplying oxygen to the stack,
wherein the stack comprises:
one or more electricity generating elements having a membrane-electrode assembly and an inner separator, the inner separator being disposed on either side of the membrane-electrode assembly; and
a pair of outermost separators positioned at opposite ends of the one or more electricity generating elements, respectively, the pair of outermost separators forming current collecting units having opposite polarities,
wherein the pair of outermost separators are fastened to provide a coupling force to the electricity generating elements in an opposing direction and to closely connect the electricity generating elements with each other.

14. The fuel cell system of claim 13, wherein the one or more electricity generating elements comprise a plurality of electricity generating elements, the plurality of the electricity generating elements being stacked with each other to form the stack.

15. The fuel cell system of claim 13, wherein the fuel supplier comprises a fuel tank for storing the fuel containing hydrogen, and a fuel pump coupled to the fuel tank.

16. The fuel cell system of claim 15, wherein the fuel supplier includes a reformer coupled to the one or more electricity generating elements and the fuel tank, the reformer being supplied with the fuel from the fuel tank to generate a hydrogen reformate, then supplying the hydrogen reformate to the one or more electricity generating elements.

17. The fuel cell system of claim 13, wherein the oxygen supplier includes a pump for drawing an oxidizing agent and supplying the oxidizing agent to the one or more electricity generating elements.

18. The fuel cell system of claim 13, wherein one of the pair of outermost separators forming the current collecting units has hydrogen passage paths formed on a side thereof adjacent to its adjacent membrane-electrode assembly and to supply hydrogen gas thereto, and another one of the pair of outermost separators forming the current collecting units has oxidizing agent passage paths formed on a side thereof adjacent to its adjacent membrane-electrode assembly and to supply oxidizing agent thereto.

19. The fuel cell system of claim 18, wherein the pair of outermost separators forming the current collecting units are formed from a metallic material, and wherein the hydrogen passage paths and the oxidizing agent passage paths of the pair of outermost separators are formed on metal plates by press working.

20. The fuel cell system of claim 19, wherein the pair of outermost separators forming the current collecting units comprise a coating layer on a surface thereof, the coating layer comprising a material selected from the group consisting of gold, silver, conductive carbon, inorganic compound, boride, conductive resin, and combinations thereof.

21. The fuel cell system of claim 13, wherein the pair of outermost separators have opposing surfaces, the opposing surfaces being larger in area than the inner separator interposed between the pair of outermost separators.

22. A stack for a fuel cell system for generating electrical energy from an electrochemical reaction of hydrogen and oxygen, the stack comprising:
a plurality of electricity generating elements, each of the electricity generating elements having a membrane-electrode assembly and an inner separator, the inner separator being disposed on either side of the membrane-electrode assembly; and
a pair of outermost separators positioned at opposite ends of the electricity generating elements, respectively,
wherein the pair of outermost separators are fastened to provide a coupling force to the electricity generating elements in an opposing direction and to closely connect the electricity generating elements with each other, and
wherein a terminal element is formed at each of the pair of outermost separators to form the pair of outermost separators into current collecting units.

23. The stack for a fuel cell system of claim 22, wherein one of the pair of outermost separators forming the current collecting units has hydrogen passage paths formed on a side thereof adjacent to its adjacent membrane-electrode assembly and to supply hydrogen gas thereto, and another one of the pair of outermost separators forming the current collecting units has oxidizing agent passage paths formed on a side thereof adjacent to its adjacent membrane-electrode assembly and to supply oxidizing agent thereto.

24. The stack for a fuel cell system of claim 22, wherein the pair of outermost separators have opposing surfaces, the opposing surface being larger in area than the inner separator interposed between the pair of outermost separators.

25. The stack for a fuel cell system of claim 22, further comprising a plurality of connecting rods penetrating through all the electricity generating elements, and a plurality of nuts fastened to both ends of each of the connecting rods, wherein the pair of outermost separators are fastened to each other by the plurality of connecting rods and the plurality of nuts fastened to both ends of each of the connecting rods.

26. A method of allowing a stack of a fuel cell system to collect current for a current receiving load, the stack having a plurality of electricity generating elements and a pair of outermost separators, each of the electricity generating elements having a membrane-electrode assembly and an inner separator, the inner separator being disposed on either side of the membrane-electrode assembly, the pair of outermost separators being positioned at opposite ends of the electricity generating elements, respectively, the method comprising:
fastening the pair of outermost separators to provide a coupling force to the electricity generating elements in an opposing direction and to closely connect the electricity generating elements with each other; and
forming a terminal element at each of the pair of outermost separators, the terminal element being electrically coupleable to the current receiving load.
